(19) United States
(12) Patent Application Publication
(10) Pub. No.: US 2026/0253178 A1
(43) Pub. Date: Aug. 27, 2026

(54) POINT CLOUD FUSION

(71) Applicant: SHINING 3D TECH CO., LTD., Hangzhou (CN)

(72) Inventors: Bintao ZHAO, Hangzhou (CN); Tengfei JIANG, Hangzhou (CN); Jian ZHANG, Hangzhou (CN); Yongjie JIA, Hangzhou (CN); Zhongwei LIN, Hangzhou (CN); Yu LIU, Hangzhou (CN)

(73) Assignee: SHINING 3D TECH CO., LTD., Hangzhou (CN)

(21) Appl. No.: 19/651,695

(22) Filed: Apr. 18, 2026

Related U.S. Application Data
(63) Continuation of application No. PCT/CN2024/124699, filed on Oct. 14, 2024.

(30) Foreign Application Priority Data
Oct. 20, 2023 (CN) 202311370573.9

(51) Int. Cl. G06T 5/50

(52) U.S. Cl. CPC G06T 5/50; G06T 2207/10028; G06T 2207/20221

(57) ABSTRACT

A point cloud fusion method includes: acquiring a to-be-fused point cloud; determining a target deformation field corresponding to the to-be-fused point cloud; adjusting a current observation point cloud to obtain a first observation point cloud; adjusting the to-be-fused point cloud to obtain a first to-be-fused point cloud; copying first to-be-fused points in the first to-be-fused point cloud to obtain a copy point cloud corresponding to the first to-be-fused point cloud; updating the copy point cloud and the first observation point cloud to obtain an updated copy point cloud and an updated first observation point cloud; and fusing the updated first observation point cloud and the updated copy point cloud to enable the updated copy point cloud and the updated first observation point cloud to be located at an updated zero isosurface.

### CROSS-REFERENCE TO RELATED APPLICATIONS

The application is a continuation of International Application No. PCT/CN2024/124699, filed on October 14, 2024, which claims the benefit of priority to Chinese Patent Application No. 202311370573.9, filed on October 20, 2023, both of which are incorporated herein by reference in their entireties.

### TECHNICAL FIELD

This application relates to the field of computer vision technology, and in particular, to a point cloud fusion method and apparatus, an electronic device, and a storage medium.

### BACKGROUND

Point cloud fusion is an important step in reconstructing three-dimensional models. However, some point cloud fusion methods are mainly applicable to rigid distance fields. In practice, during the scanning process, a scanned environment often exhibits a non-rigid distance field. For example, due to a change in position and/or posture of a scanned object, or a deformation of a surface of the scanned object, the scanned environment exhibits a non-rigid distance field.

In a first aspect, an embodiment of this application provides a point cloud fusion method, including: acquiring a to-be-fused point cloud; determining a target deformation field corresponding to the to-be-fused point cloud; adjusting, based on the target deformation field, a current observation point cloud to obtain a first observation point cloud; adjusting, based on the target deformation field and a pose of the to-be-fused point cloud, the to-be-fused point cloud to obtain a first to-be-fused point cloud; copying first to-be-fused points in the first to-be-fused point cloud to obtain a copy point cloud corresponding to the first to-be-fused point cloud; updating the copy point cloud and the first observation point cloud to obtain an updated copy point cloud and an updated first observation point cloud; and fusing the updated first observation point cloud and the updated copy point cloud to enable the updated copy point cloud and the updated first observation point cloud to be located at an updated zero isosurface.

In a second aspect, an embodiment of this application further provides a point cloud fusion apparatus, including: a to-be-fused point cloud acquisition module configured to acquire a to-be-fused point cloud; a target deformation field determination module configured to determine a target deformation field corresponding to the to-be-fused point cloud; an updating module configured to adjust, based on the target deformation field, a current observation point cloud to obtain a first observation point cloud, adjust, based on the target deformation field and a pose of the to-be-fused point cloud, the to-be-fused point cloud to obtain a first to-be-fused point cloud, copy first to-be-fused points in the first to-be-fused point cloud to obtain a copy point cloud corresponding to the first to-be-fused point cloud, and update the copy point cloud and the first observation point cloud to obtain an updated copy point cloud and an updated first observation point cloud; and a fusion module configured to fuse the updated first observation point cloud and the updated copy point cloud to enable the updated copy point cloud and the updated first observation point cloud to be located at an updated zero isosurface.

In a third aspect, an embodiment of this application further provides an electronic device, including: one or more processors and a memory; where the one or more processors are configured to, by invoking a program or an instruction stored in the memory, execute steps of the above method.

In a fourth aspect, an embodiment of this application further provides a non-transitory computer-readable storage medium storing a program or an instruction, where the program or the instruction, when executed by one or more processors, implements steps of the above method.

The technical solution provided by the embodiments of the application includes: acquiring a to-be-fused point cloud; determining a target deformation field corresponding to the to-be-fused point cloud; adjusting a current observation point cloud based on the target deformation field to obtain a first observation point cloud; adjusting the to-be-fused point cloud based on the target deformation field and a pose of the to-be-fused point cloud to obtain a first to-be-fused point cloud; copying first to-be-fused points in the first to-be-fused point cloud to obtain a copy point cloud corresponding to the first to-be-fused point cloud; updating the copy point cloud and the first observation point cloud to obtain an updated copy point cloud and an updated first observation point cloud; and fusing the updated first observation point cloud and the updated copy point cloud to enable the updated copy point cloud and the updated first observation point cloud to be located at an updated zero isosurface. This technical solution is applicable to real-time point cloud fusion for a non-rigid distance field, and can improve accuracy of point cloud fusion.

### BRIEF DESCRIPTION OF DRAWINGS

The accompanying drawings, which are incorporated in and constitute a part of this specification, illustrate embodiments consistent with this application and together with the description serve to explain the principles of this application.

To illustrate the technical solutions in the embodiments of the application more clearly, the accompanying drawings required for describing the embodiments are briefly introduced below. Apparently, for those of ordinary skill in the art, other drawings may be obtained from these drawings without creative effort.

FIG. 1 is a flowchart of a point cloud fusion method according to exemplary embodiments of this application.

FIG. 2A-FIG. 2F are schematic diagrams of a fusion principle according to exemplary embodiments of this application.

FIG. 3 is a structural diagram of a point cloud fusion apparatus according to exemplary embodiments of this application.

FIG. 4 is a structural diagram of hardware of an electronic device according to exemplary embodiments of this application.

### DETAILED DESCRIPTION

To more clearly understand the above objectives, features, and advantages of this application, the solutions of this application are further described below. It is to be noted that, in the absence of conflict, the embodiments of this application and features in the embodiments may be combined with each other.

In the following description, numerous specific details are set forth to facilitate a full understanding of this application. However, this application may also be implemented in other manners different from those described herein. Apparently, the embodiments in the specification are some of the embodiments of this application, not all of them.

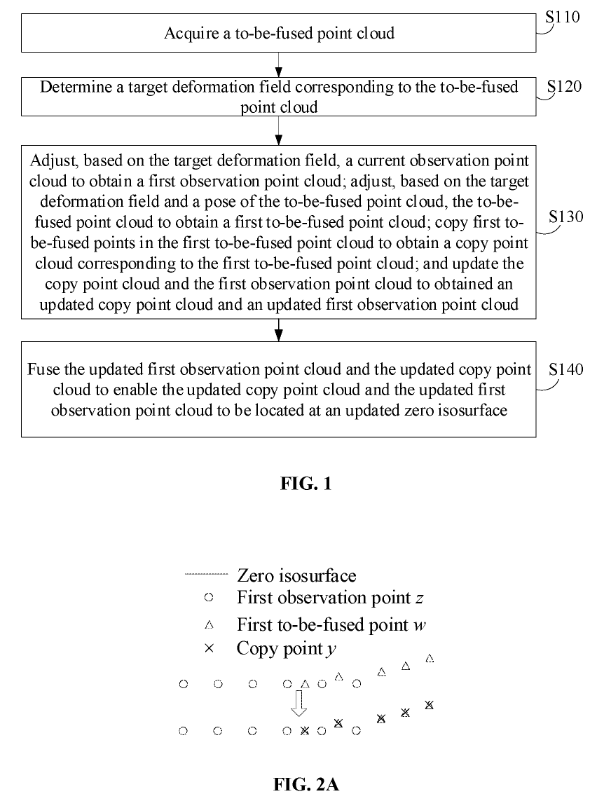

FIG. 1 is a flowchart of a point cloud fusion method according to exemplary embodiments of this application. The point cloud fusion method provided in this application may be executed by a processor of an electronic device. Referring to FIG. 1, the point cloud fusion method includes steps S110 to S140.

At step S110: a to-be-fused point cloud is acquired.

The to-be-fused point cloud is a point cloud that needs to be fused with observation points. For example, the to-be-fused point cloud may be a next frame of point cloud after a last frame of fused point cloud. For example, at a certain moment, N frames of point clouds have been fused, and the to-be-fused point cloud is the (N+1)^{th} frame of point cloud, where N is a positive integer.

The to-be-fused point cloud may also be consecutive M frames of point clouds after the last frame of fused point cloud. For example, at a certain moment, N frames of point clouds have been fused, and the to-be-fused point cloud is a point cloud set including the (N+1)^{th} frame to the (N+M)^{th} frame of point clouds, where N and M are both positive integers.

At step S120: a target deformation field corresponding to the to-be-fused point cloud is determined.

It can be understood that when a state of a currently scanned environment changes, a deformation field of a non-rigid distance field needs to be updated.

Since the scanned environment may include multiple objects (such as people, animals, or objects), one or more of positions, postures, and shapes of these objects may change, causing the scanned environment to have multiple states. For example, the scanned environment is an empty room with a door on a wall. When the door is at different opening angles, the scanned environment is in different states.

The non-rigid distance field can be regarded as a distance field function, where an independent variable is a coordinate of a point in the point cloud in a world coordinate system, and a dependent variable is a distance from the point to a surface of a specified object (hereinafter referred to as a zero isosurface). In the embodiments of the application, the distance field is constructed using a surface of the specified object as the zero isosurface. Since the scanned environment is in different states, for example, the door is at different opening angles, the distance field is non-rigid, i.e., different states of the scanned environment correspond to different non-rigid distance fields.

Assume that N frames of point clouds have been fused, and the (N+1)^{th} frame of point cloud is to be fused. During the scanning of the specified object using a scanning device, the state of the scanned environment changes in a period between a moment when the N^{th} frame of point cloud is scanned and a moment when the (N+1)^{th} frame of point cloud is scanned. That is, in the period between the moment when the N^{th} frame of point cloud is scanned and the moment when the (N+1)^{th} frame of point cloud is scanned, the state of the scanned environment changes. A current deformation field corresponding to the N^{th} frame of point cloud and the target deformation field corresponding to the (N+1)^{th} frame of point cloud indicate the above change.

The target deformation field can be used to describe a change relationship from one non-rigid distance field to another non-rigid distance field. For example, assume that the scanned environment includes a first state and a second state. If the scanned environment is in the first state, it can be described using a first non-rigid distance field; if the scanned environment is in the second state, it can be described using a second non-rigid distance field. The target deformation field can describe a change relationship from the first non-rigid distance field to the second non-rigid distance field.

At step S130: based on the target deformation field, a current observation point cloud is adjusted to obtain a first observation point cloud; based on the target deformation field and a pose of a scanning device that acquires the to-be-fused point cloud (i.e., the pose of the to-be-fused point cloud), the to-be-fused point cloud is adjusted to obtain a first to-be-fused point cloud; first to-be-fused points in the first to-be-fused point cloud are copied to obtain a copy point cloud corresponding to the first to-be-fused point cloud; and the copy point cloud and the first observation point cloud are updated to obtained an updated copy point cloud and an updated first observation point cloud.

It can be understood that the current observation point cloud is a fused point cloud. For example, assuming that at a certain moment, N frames of point clouds have been fused, and the (N+1)^{th} frame of point cloud is to be fused. The fused N frames of point clouds are the current observation point cloud, and a current observation point is a point in the current observation point cloud.

The essence of this step is to transform the current observation points in the first non-rigid distance field into first observation points in the second non-rigid distance field by using the target deformation field.

For example, the scanned environment is an empty room with a door on a wall. When the scanned environment is in a first state, the door has an opening angle of 45° (e.g., the angle between the door and the wall is 45°); when the scanned environment is in a second state, the door has an opening angle of 90° (e.g., the angle between the door and the wall is 90°). The first N frames of point clouds are collected when the door opening angle is 45°, and the (N+1)^{th} frame of point cloud is collected when the door opening angle is 90°. Assuming that the scanned object is the door, and the zero isosurface is a surface of the door, at the moment of collecting the N^{th} frame of point cloud by using the scanning device, the zero isosurface is at zero isosurface 1 in the world coordinate system; at the moment of collecting the (N+1)^{th} frame of point cloud, the zero isosurface is at zero isosurface 2 in the world coordinate system. Before adjustment of the current observation points, i.e., at the moment of collecting the N^{th} frame of point cloud, the current observation points are at zero isosurface 1, and a normal of each current observation point is perpendicular to zero isosurface 1. It can be understood that the normal of the current observation point refers to a direction vector perpendicular to the zero isosurface 1 at the current observation point. At the moment of collecting the (N+1)^{th} frame of point cloud, the current observation points are adjusted to obtain first observation points which are at zero isosurface 2, and a normal of each first observation point is perpendicular to the zero isosurface 2. It can be understood that the normal of the first observation point refers to a direction vector perpendicular to the zero isosurface 2 at the first observation point. In other words, the first observed point cloud is obtained after the current observed point cloud is deformed by the target deformation field, and the first observed point cloud defines the zero isosurface 2.

There are various implementation methods for this step, and the application does not impose limitations. For example, the implementation method for this step includes: determining, based on the target deformation field and positions and normals of the current observation points, target positions and target normals of the current observation points in the current observation point cloud; adjusting the positions and normals of the current observation points to make the positions and normals of the adjusted observation points consistent with the target positions and target normals, where the adjusted observation points are first observation points, and a point cloud composed of the first observation points is the first observation point cloud. In some examples, based on the target deformation field, adjusting the current observation point cloud to obtain the first observation point cloud includes: based on the target deformation field, adjusting normals and positions of the current observation points in the current observation point cloud to obtain the first observation point cloud.

The target position of a current observation point is a position where the adjusted observation point (the first observation point) should be located. For example, a distance from the first observation point to zero isosurface 2 is 0. The target normal of the current observation point is a normal that the adjusted observation point should have. For example, the normal of the first observation point is a direction vector perpendicular to zero isosurface 2 at the first observation point.

It is to be noted that if the current observation point cloud includes multiple current observation points, when performing this step, it is necessary to determine a target position and a target normal for each current observation point, and adjust the position and normal of each current observation point to make the position and normal of each adjusted current observation point (first observation point) consistent with the corresponding target position and target normal.

In some embodiments, based on the target deformation field corresponding to the to-be-fused point cloud and pose data of the scanning device that acquires the to-be-fused point cloud, the to-be-fused point cloud is adjusted to obtain the first to-be-fused point cloud, where adjusting the to-be-fused point cloud includes adjusting positions and normals of to-be-fused points in the to-be-fused point cloud. The pose data of the scanning device includes rotation data and translation data of the scanning device. The target deformation field corresponding to the to-be-fused point cloud may be, for example, a transformation relationship describing a transformation from a coordinate system of the scanning device to a non-rigid distance field in a current state (e.g., a second non-rigid distance field). This is intended to improve accuracy of a subsequent fusion result. In some embodiments, based on the target deformation field and the pose of the to-be-fused point cloud, adjusting the to-be-fused point cloud to obtain the first to-be-fused point cloud includes: transforming, based on the target deformation field and the pose of the to-be-fused point cloud, the to-be-fused point cloud to a second non-rigid distance field coordinate system to obtain the first to-be-fused point cloud. It can be understood that the pose of the to-be-fused point cloud is used to calculate positions and normals of the to-be-fused point cloud in the coordinate system of the scanning device, and the target deformation field transforms the to-be-fused point cloud from the coordinate system of the scanning device to the second non-rigid distance field coordinate system. In some examples, the scanning device communicates with the electronic device, such that the processor of the electronic device can obtain the to-be-fused point cloud acquired by the scanning device through the communication between them.

At step S140: the updated first observation point cloud and the updated copy point cloud are fused to enable the updated copy point cloud and the updated first observation point cloud to be located at an updated zero isosurface.

There are various implementation methods for this step, and this application does not impose limitations. For example, the implementation method for this step includes: determining, by updating distances from updated copy points in the updated copy point cloud to a first zero isosurface and updating distances from updated first observation points in the updated first observation point cloud to a second zero isosurface, the updated zero isosurface; moving the updated first observation point cloud and the updated copy point cloud onto the updated zero isosurface.

It can be understood that the zero isosurface describes a surface of an object in the scanned environment. The zero isosurface can be regarded as a surface fitted by points. Each time fusion is performed, the zero isosurface is updated.

In an embodiment, updating the copy point cloud and the first observation point cloud to obtain the updated copy point cloud and the updated first observation point cloud includes: updating, based on the first observation point cloud and the first to-be-fused point cloud, normals of copy points in the copy point cloud to obtain first copy points; updating, based on the first to-be-fused point cloud, normals of the first observation points in the first observation point cloud to obtain normal-updated first observation points; updating, based on the first to-be-fused point cloud and the normal-updated first observation points, distances from the first copy points to the updated zero isosurface; updating, based on the first to-be-fused point cloud, distances from the normal-updated first observation points to the updated zero isosurface; fusing the updated first observation point cloud and the updated copy point cloud includes: adjusting, based on the normals of the first copy points and the distances from the first copy points to the updated zero isosurface, positions of the first copy points to obtain second copy points, where a distance from each second copy point to the updated zero isosurface is 0; adjusting, based on the normals of the normal-updated first observation points and the distances from the normal-updated first observation points to the updated zero isosurface, positions of the normal-updated first observation points to obtain second observation points, where a distance from each second observation point to the updated zero isosurface is 0.

The current observation points are points in the current observation point cloud, the to-be-fused points are points in the to-be-fused point cloud, and the copy points are points in the copy point cloud.

Attributes of a point include coordinates, normal, weight, color, distance to the zero isosurface, etc. The weight indicates a confidence level of the point. A higher weight means a higher confidence level.

The above embodiment may include the following steps: 1) initializing an empty first non-rigid distance field;2) obtain a to-be-fused point cloud through a scanning device; 3) determine a target deformation field corresponding to the to-be-fused point cloud, and apply the target deformation field to the first non-rigid distance field, i.e., replace a deformation field in the first non-rigid distance field with the target deformation field to obtain a second non-rigid distance field; 4) if there is a new to-be-fused image frame, fuse the new to-be-fused image frame into the second non-rigid distance field; 5) if the above steps need to be terminated, terminate the operations; otherwise, go to step 2).

Step 4) further includes: 4.1) applying the target deformation field to all observation points in the first non-rigid distance field (changing positions and normals of the observation points), where all observation points change their positions based on current distances to zero isosurface 2 and their own normals to make distances from themselves to zero isosurface 2 be 0, obtaining a first observation point cloud composed of first observation points in the second

non-rigid distance field coordinate system corresponding to the target deformation field; 4.2) transforming, based on the target deformation field and the pose of the scanning device that acquires the to-be-fused point cloud, positions and normals of all points in the to-be-fused point cloud into the second non-rigid distance field coordinate system corresponding to the target deformation field to obtain a first to-be-fused point cloud after deformation and pose adjustment, where a set of all points in the first to-be-fused point cloud is W, and each first to-be-fused point w includes attribute information such as position, normal, color, weight (confidence level of the first to-be-fused point, where a higher value indicates higher accuracy); 4.3) denoting a set of all first observation points in the second non-rigid distance field coordinate system as Z; 4.4) creating, at positions of the first to-be-fused point cloud W, a copy point set having the same positions as the first to-be-fused points, i.e., a copy point cloud Y, where positions, normals, and attributes of all copy points in the copy point cloud Y are identical to positions, normals, and attributes of the first to-be-fused points in the first to-be-fused point cloud W; 4.5) for each copy point y in the copy point cloud Y, updating, by using all points in the first observation point cloud Z and the first to-be-fused point cloud W , a normal of each copy point y to obtain a first copy point y’, where the step includes: for any one point p in the first observation point cloud Z and the first to-be-fused point cloud W, if a distance (e.g., Euclidean distance) from the point p to the copy point y is less than a predetermined threshold (e.g., 3-5 times a fusion radius), calculating an influence weight of the point p on the normal of the copy point y based on a weight of the point p, a normal of the point p, and the distance from the point p to the copy point y, and updating the normal of each copy point y (i.e., updating the normal of the copy point y relative to a nearby surface) to obtain the first copy point y '; 4.6) for each first observation point z in the first observation point cloud Z, updating, by using a first to-be-fused point w in the first to-be-fused point cloud W, a normal of each first observation point z to obtain a normal-updated first observation point z ', where the update method is the same as step 4.5); 4.7) for each first copy point y ' in the first copy point cloud Y ' , updating, by using points in the first observation point cloud Z and the first to-be-fused point cloud W, other information (including color, weight, etc.) of each first copy point y ', where the step includes: for any one point p in the first observation point cloud Z and the first to-be-fused point cloud W, if a distance (e.g., Euclidean distance) from the point p to the first copy point y ' is less than a predetermined threshold (e.g., 3-5 times a fusion radius), calculating, based on a weight of the point p, a normal of the point p, and the Euclidean distance from the point p to the first copy point y ', an influence weight of the point p on the first copy point y '; updating, based on the calculated weight (weighted average) (the update does not include position

update), information such as color, weight, and a distance to zero isosurface 2 of the first copy point y ', where the distance to zero isosurface 2 is calculated from a tangent plane distance (with positive or negative sign) from the point p to the first copy point y '; in other words, based on a point p in the first observed point cloud Z and the first target fusion point cloud W that meets a distance requirement, the zero isosurface 2 is updated with a distance from point p to a tangent plane of the first copy points y ', to determine a zero isosurface 3; 4.8) for each normal-updated first observation point z ' in the normal-updated first observation point cloud Z ', updating, by using a first to-be-fused point w in the first to-be-fused point cloud W, other information (including color, weight, etc.) of the normal-updated first observation point z ', where the update method is the same as step 4.7), in other words, based on a point p in the first to-be-fused point cloud W that meets a distance requirement, the zero isosurface 3 is updated with a distance from the point p to a tangent plane of the normal-updated first observation points z ', to determine a zero isosurface 4, that is the updated zero isosurface; 4.9) for each point n in the first copy point cloud Y 'and the normal-updated first observation point cloud Z ', changing, based on a distance from the point n to the updated zero isosurface and its own normal, a position of the point n to make the distance from the point n to the updated zero isosurface is 0, to obtain a second copy point cloud Y ' ' and a second observation point cloud Z ' '; 4.10) for each second copy point y '' in the second copy point cloud Y'', if a Euclidean distance between the second copy point y '' and any one second observation point z '' in the second observation point cloud Z '' is less than a fusion radius, removing the second copy point y ''from the second copy point cloud Y''; 4.11) adding the second copy points y '' in the second copy point cloud Y'' after removing redundant points to the second observation point cloud Z ' ', and the step ends.

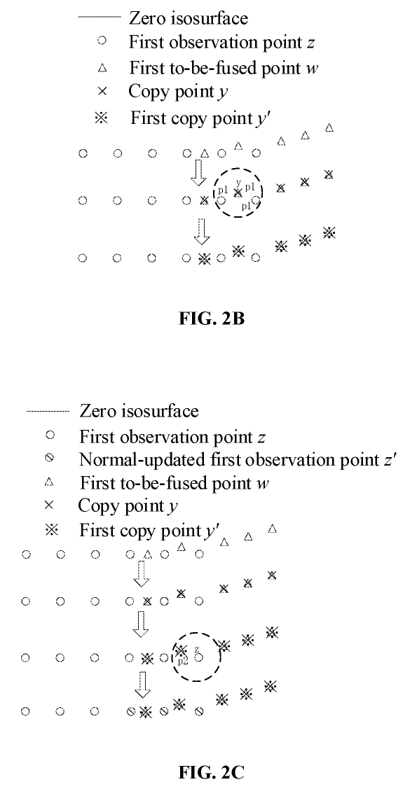

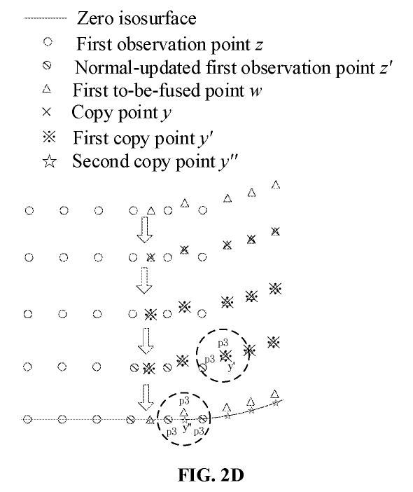

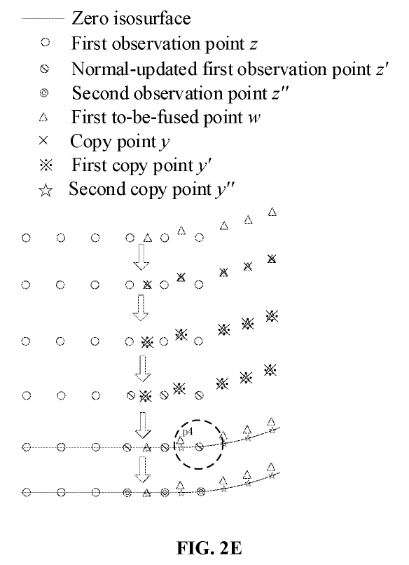

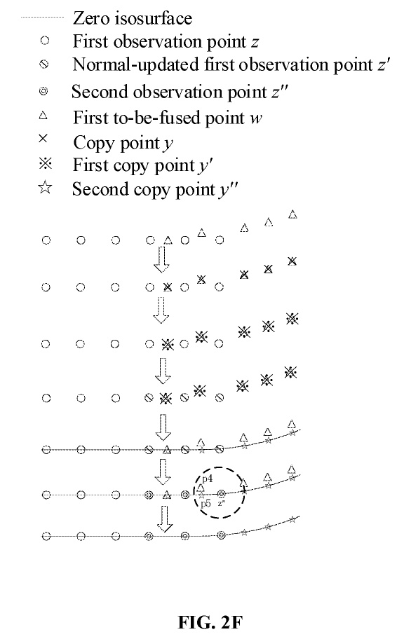

FIG. 2A- FIG. 2F are schematic diagrams of a fusion principle according to exemplary embodiments of this application. For example, referring to FIG. 2A, a first to-be-fused point cloud after coordinate system adjustment based on the target deformation field and the pose data is represented as W (in FIG. 2A- FIG. 2F, Δ represents first to-be-fused points w in the first to-be-fused point cloud W), a first observation point cloud in the second non-rigid distance field is Z (in FIG. 2A- FIG. 2F, ○ represent a first observation point z in the first observation point cloud Z), and the first to-be-fused point cloud W is copied to obtain a copy point cloud Y (in FIG. 2A- FIG. 2F, × represents copy points y in the copy point cloud Y). The copy point cloud Y includes multiple copy points y, and the copy points y in the copy point cloud Y correspond one-to-one with the first to-be-fused points w in the first to-be-fused point cloud W. A copy point y and its corresponding first to-be-fused point w have the same position and the same normal.

Referring to FIG. 2B, for each copy point y in the copy point cloud Y, points p1 satisfying a first preset condition are determined from the first observation point cloud Z and the first to-be-fused point cloud W. The first preset condition may include: a distance (e.g., Euclidean distance) between a point p1 and the copy point y being less than or equal to a preset distance threshold. In other words, the points p1 include first observation points z and first to-be-fused points w whose Euclidean distance to the copy point y is less than or equal to a preset distance threshold. In practice, a number of determined points p1 may be one or multiple. For example, as shown in FIG. 2B, within a dashed circle centered at any one copy point y (typically 3-5 times the fusion radius), three points p1 are included, two of the three points p1 are first observation points z and one of the three points p1 is a first to-be-fused point w. For each copy point y, an influence weight of each point p1 on the normal of the copy point y is calculated based on a weight of each point p1, a normal of each point p1, and a distance from each point p1 to the copy point y; the normal of the copy point y is updated based on the influence weight of each point p1 on the normal of the copy point y and the normal of each point p1, to obtain a first copy point y ' (represented by ※ in FIG. 2B) and a normal-updated copy point cloud Y ' , i.e., the first copy point cloud Y ' .

Referring to FIG. 2C, for each first observation point z in the first observation point cloud Z, points p2 satisfying a second preset condition are determined from the first to-be-fused point cloud W. The second preset condition may include: a distance (e.g., Euclidean distance) between a point p2 and the first observation point z being less than or equal to a preset distance threshold. In other words, the points p2 include first to-be-fused points w whose Euclidean distance to the first observation point z is less than or equal to a preset distance threshold. In practice, a number of determined points p2 may be 0, one, or multiple. For example, as shown in FIG. 2C, within a dashed circle centered at any one first observation point z (typically 3-5 times the fusion radius), one point p2 is included, which is a first to-be-fused point w. For each first observation point z, an influence weight of each point p2 on the normal of the first observation point z is calculated based on a weight of each point p2, a normal of each point p2, and a distance from each point p2 to the first observation point z; the normal of the first observation point z is updated based on the influence weight of each point p2 on the normal of the first observation point z and the normal of each point p2, to obtain a normal-updated first observation point z ' and a normal-updated first observation point cloud Z ' composed of the normal-updated first observation points z '.

Referring to FIG. 2D, for each first copy point y ' in the first copy point cloud Y ' , points p3 satisfying a third preset condition are determined from the normal-updated first observation point cloud Z ' and the first to-be-fused point cloud W. The third preset condition may include: a distance (e.g., Euclidean distance) between a point p3 and the first copy point y ' being less than or equal to a preset distance threshold. In other words, the points p3 include normal-updated first observation points z ' and first to-be-fused points w whose Euclidean distance to the first copy point y ' is less than or equal to a preset distance threshold. In practice, a number of determined points p3 may be one or multiple. For example, as shown in FIG. 2D, within a dashed circle centered at any one first copy point y ' (typically 3-5 times the fusion radius), two points p3 are included, one of the two points p3 is a normal-updated first observation point z ' and one of the two points p3 is a first to-be-fused point w. For each first copy point y ', an influence weight of each point p3 on the distance of the first copy point y ' is calculated based on a weight of each point p3, a normal of each point p3, and a distance from each point p3 to the first copy point y '; a distance from the first copy point y ' to a zero isosurface is updated based on the influence weight of each point p3 on the distance of the first copy point y ', where the distance from the first copy point y ' to the zero isosurface is calculated from a tangent plane distance (with positive or negative sign) from the point p3 to the first copy point y '. A position of the first copy point y ' is adjusted based on the normal of the first copy point y ' and the distance from the first copy point y ' to the updated zero isosurface to obtain a second copy point y '' (represented by ☆ in FIG. 2D), where a distance from the second copy point y '' to the updated zero isosurface is 0. The updated zero isosurface is determined by updating the distances from the first copy points to a first zero isosurface (i.e., the abovementioned zero isosurface 2) and updating the distances from the normal-updated first observation points to a second zero isosurface (i.e., the abovementioned zero isosurface 3). In some embodiments, the updated zero isosurface is a new surface that a weighted sum of squares of distances from all points in the point clouds (such as, the first copy points and the normal-updated first observation points) to the new surface is minimized.

Referring to FIG. 2E, for each normal-updated first observation point z ' in the normal-updated first observation point cloud Z ', points p4 satisfying a fourth preset condition are determined from the first to-be-fused point cloud W. The fourth preset condition may include: a distance (e.g., Euclidean distance) between a point p4 and the normal-updated first observation point z ' being less than or equal to a preset distance threshold. In other words, the points p4 include first to-be-fused points w whose Euclidean distance to the normal-updated first observation point z ' is less than or equal to a preset distance threshold. In practice, a number of determined points p4 may be 0, one, or multiple. For example, as shown in FIG. 2E, within a dashed circle centered at any one normal-updated first observation point z ' (typically 3-5 times the fusion radius), one point p4 is included, which is a first to-be-fused point w. For each normal-updated first observation point z ', an influence weight of each point p4 on the distance of the normal-updated first observation point z ' is calculated based on a weight of each point p4, a normal of each point p4, and a distance from each point p4 to the normal-updated first observation point z '; a distance from the normal-updated first observation point z ' to the zero isosurface 3 is updated based on the influence weight of each point p4 on the distance of the normal-updated first observation point z ' and the normal of each point p4, where the distance from the normal-updated first observation point z ' to the zero isosurface 3 is calculated from a tangent plane distance (with positive or negative sign) from the point p4 to the normal-updated first observation point z '. A position of the normal-updated first observation point z ' is adjusted based on the normal of the normal-updated first observation point z ' and the distance from the normal-updated first observation point z ' to the updated zero isosurface to obtain a second observation point z ' ', where a distance from the second observation point z '' to the updated zero isosurface is 0. The updated zero isosurface is determined by updating the distances from the first copy points to a zero isosurface 2 and updating the distances from the normal-updated first observation points to a zero isosurface 3. In some embodiments, the updated zero isosurface is a new surface that a weighted sum of squares of distances from all points in the point clouds (the first copy points, the normal-updated first observation points) to the new surface is minimized.

In some embodiments, colors and weights of the second copy points are updated based on the first to-be-fused points in the first to-be-fused point cloud and the normal-updated first observation points (e.g., based on attributes of the first to-be-fused points and attributes of the normal-updated first observation points); colors and weights of the second observation points are updated based on the first to-be-fused points in the first to-be-fused point cloud (e.g., based on attributes of the to-be-fused points in the to-be-fused point cloud).

"Updating colors and weights of the second copy points based on the first to-be-fused points in the first to-be-fused point cloud and the normal-updated first observation points (e.g., based on attributes of the first to-be-fused points and attributes of the normal-updated first observation points)" may include: for each second copy point y ' ' in the second copy point cloud Y'', determining, from the normal-updated first observation point cloud Z ' and the first to-be-fused point cloud W, points p3 satisfying a third preset condition. The third preset condition may include: a distance (e.g., Euclidean distance) between a point p3 and the second copy point y '' being less than or equal to a preset distance threshold. In practice, a number of determined points p3 may be one or multiple. As shown in FIG. 2D, within a dashed circle centered at a second copy point y '', three points p3 are included, two of the three points p3 are normal-updated first observation points z ' and one of the three points p3 is a first to-be-fused point w. For each second copy point y '', a color influence weight and a confidence influence weight of each point p3 on the second copy point y '' are calculated based on a weight of each point p3, a normal of each point p3, and a distance from each point p3 to the second copy point y ''; a color of the second copy point y '' is updated based on the color influence weight of each point p3 on the second copy point y ''; a weight of the second copy point y '' is updated based on the confidence influence weight of each point p3 on the second copy point y ''.

"Updating colors and weights of the second observation points based on the first to-be-fused points in the first to-be-fused point cloud (e.g., based on attributes of the first to-be-fused points)" may include: for a second observation point z '' in the second observation point cloud Z’', determining, from the first to-be-fused point cloud W, points p4 satisfying a fourth preset condition, as shown in FIG. 2F. The fourth preset condition may include: a Euclidean distance between a point p4 and the second observation point z '' being less than or equal to a preset distance threshold. In practice, a number of determined points p4 may be 0, one, or multiple. For each second observation point z '', a color influence weight and a confidence influence weight of each point p4 on the second observation point z '' are calculated based on a weight of each point p4, a normal of each point p4, and a distance from each point p4 to the second observation point z ''; a color of the second observation point z '' is updated based on the color influence weight of each point p4 on the second observation point z '' and the normal of each point p4; a weight of the second observation point z '' is updated based on the confidence influence weight of each point p4 on the second observation point z '' and the normal of each point p4.

By acquiring a to-be-fused point cloud; determining a target deformation field corresponding to the to-be-fused point cloud; adjusting, based on the target deformation field, a current observation point cloud to obtain a first observation point cloud; adjusting, based on the target deformation field and a pose of the to-be-fused point cloud, the to-be-fused point cloud to obtain a first to-be-fused point cloud; copying first to-be-fused points in the first to-be-fused point cloud to obtain a copy point cloud corresponding to the first to-be-fused point cloud; updating the copy point cloud and the first observation point cloud to obtain an updated copy point cloud and an updated first observation point cloud; and fusing the updated first observation point cloud and the updated copy point cloud to enable the updated copy point cloud and the updated first observation point cloud to be located at an updated zero isosurface. The essence is that during the fusion process, positions and normals of points in the fused point cloud are continuously updated based on the target deformation field, such that the fused points are always at the latest zero isosurface. This method is applicable to real-time point cloud fusion for a non-rigid distance field, and can improve accuracy of point cloud fusion.

Based on the above technical solution, after S140, the method further includes: determining redundant points among the second copy points; deleting the redundant points and the to-be-fused point cloud.

Referring to FIG. 2F, for each second copy point y '' in the second copy point cloud Y'', a point p5 satisfying a fifth preset condition is determined from the second observation point cloud Z ''. The fifth preset condition may include: a Euclidean distance between a point p5 and the second observation point z '' being less than or equal to a preset distance threshold. If there exists a point p5 satisfying the fifth preset condition, the point p5 satisfying the fifth preset condition is determined as a redundant point, and the point p5 satisfying the fifth preset condition is subsequently deleted. If there is no point p5 satisfying the fifth preset condition, the second copy point y '' that does not satisfy the fifth preset condition is determined as an available point, and the second copy point y '' that does not satisfy the fifth preset condition (i.e., being the available point) is subsequently retained.

Assuming that this fusion is performed for the (N+1)^{th} frame of point cloud, after deleting the redundant points and the to-be-fused points, the remaining second copy points and second observation points will serve as current observation points for fusion of the (N+2)^{th} frame of point cloud. Therefore, by deleting the redundant points and the to-be-fused points, a fusion speed of subsequent fusions can be improved.

It should be noted that the foregoing method embodiments are described as a series of action combinations for simplicity. However, those skilled in the art should understand that the application is not limited by the described order of actions, because some steps may be performed in other orders or simultaneously according to this application. Furthermore, those skilled in the art should also understand that the embodiments described in the specification are exemplary embodiments, and the actions and modules involved are not necessarily required for this application.

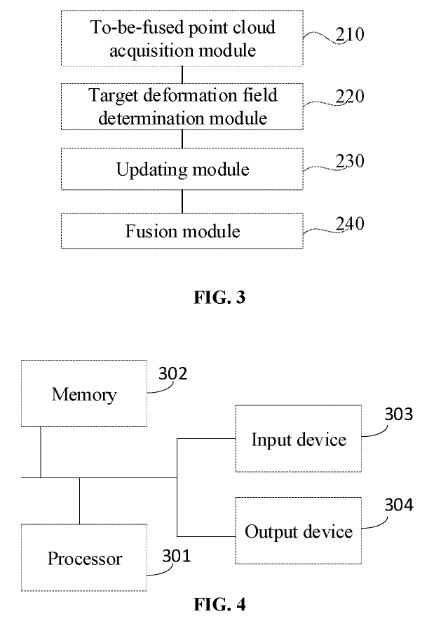

FIG. 3 is a structural diagram of a point cloud fusion apparatus according to exemplary embodiments of this application. As shown in FIG. 3, the apparatus includes: a to-be-fused point cloud acquisition module 210 configured to acquire a to-be-fused point cloud; a target deformation field determination module 220 configured to determine a target deformation field corresponding to the to-be-fused point cloud; an updating module 230 configured to adjust, based on the target deformation field, a current observation point cloud to obtain a first observation point cloud; adjust, based on the target deformation field and a pose of the to-be-fused point cloud, the to-be-fused point cloud to obtain a first to-be-fused point cloud; copy first to-be-fused points in the first to-be-fused point cloud to obtain a copy point cloud corresponding to the first to-be-fused point cloud; and update the copy point cloud and the first observation point cloud to obtain an updated copy point cloud and an updated first observation point cloud; and a fusion module 240 configured to fuse the updated first observation point cloud and the updated copy point cloud to enable the updated copy point cloud and the updated first observation point cloud to be located at an updated zero isosurface.

In some embodiments, the updating module 230 is configured to: adjust, based on the target deformation field, normals and positions of current observation points in the current observation point cloud to obtain the first observation point cloud.

In some embodiments, the updating module 230 is further configured to: update, by using the first observation point cloud and the first to-be-fused point cloud, the copy point cloud; update the first observation point cloud by using the first to-be-fused point cloud.

In some embodiments, the updating module 230 is further configured to: for each copy point in the copy point cloud, determine, from the first observation point cloud and the first to-be-fused point cloud, points whose Euclidean distance to the copy point is less than or equal to a first set distance threshold for updating the copy point; for each first observation point in the first observation point cloud, determine, from the first to-be-fused point cloud, a first to-be-fused point whose Euclidean distance to the first observation point is less than or equal to a second set distance threshold for updating the first observation point.

In some embodiments, the fusion module 240 is configured to: determine, by updating distances from updated copy points in the updated copy point cloud to a first zero isosurface and updating distances from updated first observation points in the updated first observation point cloud to a second zero isosurface, an updated zero isosurface.

In some embodiments, the fusion module 240 is configured to: move the updated first observation point cloud and the updated copy point cloud onto the updated zero isosurface.

In some embodiments, the fusion module 240 is configured to: update, based on the first observation point cloud and the first to-be-fused point cloud, normals of copy points in the copy point cloud to obtain first copy points; update, based on the first to-be-fused point cloud, normals of first observation points in the first observation point cloud to obtain normal-updated first observation points; update, based on the first to-be-fused point cloud and the normal-updated first observation points, distances from the first copy points to the updated zero isosurface; update, based on the first to-be-fused point cloud, distances from the normal-updated first observation points to the updated zero isosurface; adjust, based on normals of the first copy points and the distances from the first copy points to the updated zero isosurface, positions of the first copy points to obtain second copy points, where a distance from each second copy point to the updated zero isosurface is 0; adjust, based on normals of the normal-updated first observation points and the distances from the normal-updated first observation points to the updated zero isosurface, positions of the normal-updated first observation points to obtain second observation points, where a distance from each second observation point to the updated zero isosurface is 0.

In some embodiments, the fusion module 240 is further configured to: update, based on the first to-be-fused points and the normal-updated first observation points, colors and weights of the second copy points; update, based on the first to-be-fused points, colors and weights of the second observation points.

In some embodiments, the apparatus further includes a deletion module configured to determine redundant points in the second copy points; and delete the redundant points and the to-be-fused point cloud.

The apparatus disclosed in the above embodiments can implement the processes of the methods disclosed in the above method embodiments, having the same or corresponding beneficial effects. To avoid repetition, details are not described herein again.

FIG. 4 is a structural diagram of hardware of an electronic device according to exemplary embodiments of this application. As shown in FIG. 4, the electronic device includes: one or more processors 301, with one processor 301 as an example in FIG. 4; a memory 302; the electronic device may further include: an input device 303 and an output device 304.

The processor 301, the memory 302, the input device 303, and the output device 304 in the electronic device may be connected via a bus or other means. In FIG. 4, connection via a bus is taken as an example.

The memory 302, as a non-transitory computer-readable storage medium, may be configured to store software programs, computer-executable programs, and modules, such as program instructions/modules corresponding to the point cloud fusion method in the embodiments of this application. The processor 301 executes various functional applications and data processing of the server by running the software programs, instructions, and modules stored in the memory 302, thereby implementing the point cloud fusion method in the above method embodiments.

The memory 302 may include a program storage area and a data storage area. The program storage area may store an operating system, an application program required for at least one function; the data storage area may store data created according to use of the electronic device, etc. Additionally, the memory 302 may include high-speed random access memory, and may also include non-transitory memory, such as at least one magnetic disk storage device, flash memory device, or other non-transitory solid-state storage device. In some embodiments, the memory 302 optionally includes memory remotely located relative to the processor 301, which may be connected to a terminal device via a network. Examples of the above network include, but are not limited to, the Internet, an intranet, a local area network, a mobile communication network, and combinations thereof.

The input device 303 may be configured to receive input numeric or character information and generate key signal inputs related to user settings and functional control of the electronic device. The output device 304 may include a display device such as a display screen.

An embodiment of this application further provides a computer-readable storage medium storing a program or an instruction. The program or the instruction, when executed by a computer, causes the computer to perform a point cloud fusion method, the method including: acquiring a to-be-fused point cloud; determining a target deformation field corresponding to the to-be-fused point cloud; adjusting, based on the target deformation field, a current observation point cloud to obtain a first observation point cloud; adjusting, based on the target deformation field and a pose of the to-be-fused point cloud, the to-be-fused point cloud to obtain a first to-be-fused point cloud; copying first to-be-fused points in the first to-be-fused point cloud to obtain a copy point cloud corresponding to the first to-be-fused point cloud; updating the copy point cloud and the first observation point cloud to obtain an updated copy point cloud and an updated first observation point cloud; and fusing the updated first observation point cloud and the updated copy point cloud to enable the updated copy point cloud and the updated first observation point cloud to be located at an updated zero isosurface.

In some embodiments, the computer-executable instructions, when executed by a computer processor, may also be used to perform the technical solutions of the point cloud fusion method provided in any embodiment of this application.

Through the above description of the embodiments, those skilled in the art can clearly understand that this application can be implemented by means of software and necessary general-purpose hardware, and of course, can also be implemented by hardware. However, in many cases, the former is a better implementation. Based on such understanding, the technical solutions of this application, in essence or the part contributing to the prior art, may be embodied in the form of a software product. The computer software product may be stored in a computer-readable storage medium, such as a floppy disk, a read-only memory (ROM), a random access memory (RAM), a flash memory, a hard disk, or an optical disk of a computer, including several instructions for causing a computer device (which may be a personal computer, a server, or a network device, etc.) to perform the methods described in various embodiments of this application.

It should be noted that in this specification, relational terms such as "first" and "second" are used merely to distinguish one entity or operation from another entity or operation, and do not necessarily require or imply any such actual relationship or order between these entities or operations. Moreover, the terms "include," "comprise," or any other variations thereof are intended to encompass non-exclusive inclusion, such that a process, method, article, or device that includes a series of elements includes not only those elements but also other elements not expressly listed, or also includes elements inherent to such process, method, article, or device. Without further limitation, an element defined by the phrase "including a ..." does not preclude the presence of additional identical elements in the process, method, article, or device that includes the element.

The above are some implementations of this application, enabling those skilled in the art to understand or implement this application. Various modifications to these embodiments will be apparent to those skilled in the art. The general principles defined herein may be implemented in other embodiments without departing from the spirit or scope of this application. Therefore, this application will not be limited to the embodiments described herein, but will conform to the widest scope consistent with the principles and novel features disclosed herein.

1. A point cloud fusion method, comprising: acquiring a to-be-fused point cloud; determining a target deformation field corresponding to the to-be-fused point cloud; adjusting, based on the target deformation field, a current observation point cloud to obtain a first observation point cloud; adjusting, based on the target deformation field and a pose of the to-be-fused point cloud, the to-be-fused point cloud to obtain a first to-be-fused point cloud; copying first to-be-fused points in the first to-be-fused point cloud to obtain a copy point cloud corresponding to the first to-be-fused point cloud; updating the copy point cloud and the first observation point cloud to obtain an updated copy point cloud and an updated first observation point cloud; and fusing the updated first observation point cloud and the updated copy point cloud to enable the updated copy point cloud and the updated first observation point cloud to be located at an updated zero isosurface.

2. The point cloud fusion method according to claim 1, wherein adjusting, based on the target deformation field, the current observation point cloud to obtain the first observation point cloud, comprises: adjusting, based on the target deformation field, normals and positions of current observation points in the current observation point cloud to obtain the first observation point cloud.

3. The point cloud fusion method according to claim 1, further comprising: updating, by using the first observation point cloud and the first to-be-fused point cloud, the copy point cloud; and updating, by using the first to-be-fused point cloud, the first observation point cloud.

4. The point cloud fusion method according to claim 3, wherein updating, by using the first observation point cloud and the first to-be-fused point cloud, the copy point cloud; and updating, by using the first to-be-fused point cloud, the first observation point cloud, comprises: for each copy point in the copy point cloud, determining, from the first observation point cloud and the first to-be-fused point cloud, points whose distance to the copy point is less than or equal to a first preset distance threshold for updating the copy point; and for each first observation point in the first observation point cloud, determining, from the first to-be-fused point cloud, a first to-be-fused point whose distance to the first observation point is less than or equal to a second preset distance threshold for updating the first observation point.

5. The point cloud fusion method according to claim 1, wherein updating the copy point cloud and the first observation point cloud to obtain the updated copy point cloud and the updated first observation point cloud comprises: updating, based on the first observation point cloud and the first to-be-fused point cloud, normals of copy points in the copy point cloud to obtain first copy points; updating, based on the first to-be-fused point cloud, normals of first observation points in the first observation point cloud to obtain normal-updated first observation points; updating, based on the first to-be-fused point cloud and the normal-updated first observation points, distances from the first copy points to the updated zero isosurface; and updating, based on the first to-be-fused point cloud, distances from the normal-updated first observation points to the updated zero isosurface; and fusing the updated first observation point cloud and the updated copy point cloud comprises: adjusting, based on normals of the first copy points and the distances from the first copy points to the updated zero isosurface, positions of the first copy points to obtain second copy points, wherein a distance from each second copy point to the updated zero isosurface is 0; and adjusting, based on normals of the normal-updated first observation points and the distances from the normal-updated first observation points to the updated zero isosurface, positions of the normal-updated first observation points to obtain second observation points, wherein a distance from each second observation point to the updated zero isosurface is 0.

6. The point cloud fusion method according to claim 5, further comprising: updating, based on the first to-be-fused points and the normal-updated first observation points, colors and weights of the second copy points; and updating, based on the first to-be-fused points, colors and weights of the second observation points.

7. The point cloud fusion method according to claim 5, further comprising: determining redundant points in the second copy points; and deleting the redundant points and the to-be-fused point cloud.

8. The point cloud fusion method according to claim 1, wherein fusing the updated first observation point cloud and the updated copy point cloud to enable the updated copy point cloud and the updated first observation point cloud to be located at the updated zero isosurface, comprises: determining, by updating distances from updated copy points in the updated copy point cloud to a first zero isosurface and updating distances from updated first observation points in the updated first observation point cloud to a second zero isosurface, the updated zero isosurface; and moving the updated first observation point cloud and the updated copy point cloud onto the updated zero isosurface.

9. An electronic device, comprising: one or more processors; and a memory; wherein the one or more processors are configured to, by invoking a program or an instruction stored in the memory, perform operations comprising: acquiring a to-be-fused point cloud; determining a target deformation field corresponding to the to-be-fused point cloud; adjusting, based on the target deformation field, a current observation point cloud to obtain a first observation point cloud; adjusting, based on the target deformation field and a pose of the to-be-fused point cloud, the to-be-fused point cloud to obtain a first to-be-fused point cloud; copying first to-be-fused points in the first to-be-fused point cloud to obtain a copy point cloud corresponding to the first to-be-fused point cloud; updating the copy point cloud and the first observation point cloud to obtain an updated copy point cloud and an updated first observation point cloud; and fusing the updated first observation point cloud and the updated copy point cloud to enable the updated copy point cloud and the updated first observation point cloud to be located at an updated zero isosurface.

10. The electronic device according to claim 9, the one or more processors are further configured to perform operations comprising: updating, by using the first observation point cloud and the first to-be-fused point cloud, the copy point cloud; and updating, by using the first to-be-fused point cloud, the first observation point cloud.

11. The electronic device according to claim 9, wherein updating the copy point cloud and the first observation point cloud to obtain the updated copy point cloud and the updated first observation point cloud comprises: updating, based on the first observation point cloud and the first to-be-fused point cloud, normals of copy points in the copy point cloud to obtain first copy points; updating, based on the first to-be-fused point cloud, normals of first observation points in the first observation point cloud to obtain normal-updated first observation points; updating, based on the first to-be-fused point cloud and the normal-updated first observation points, distances from the first copy points to the updated zero isosurface; and updating, based on the first to-be-fused point cloud, distances from the normal-updated first observation points to the updated zero isosurface; and fusing the updated first observation point cloud and the updated copy point cloud comprises: adjusting, based on normals of the first copy points and the distances from the first copy points to the updated zero isosurface, positions of the first copy points to obtain second copy points, wherein a distance from a second copy point to the updated zero isosurface is 0; and adjusting, based on normals of the normal-updated first observation points and the distances from the normal-updated first observation points to the updated zero isosurface, positions of the normal-updated first observation points to obtain second observation points, wherein a distance from a second observation point to the updated zero isosurface is 0.

12. The electronic device according to claim 11, the one or more processors are further configured to perform operations comprising: updating, based on the first to-be-fused points and the normal-updated first observation points, colors and weights of the second copy points; and updating, based on the first to-be-fused points, colors and weights of the second observation points.

13. A non-transitory computer-readable storage medium storing a program or an instruction, wherein the program or the instruction, when executed by one or more processors, implements operations comprising: acquiring a to-be-fused point cloud; determining a target deformation field corresponding to the to-be-fused point cloud; adjusting, based on the target deformation field, a current observation point cloud to obtain a first observation point cloud; adjusting, based on the target deformation field and a pose of the to-be-fused point cloud, the to-be-fused point cloud to obtain a first to-be-fused point cloud; copying first to-be-fused points in the first to-be-fused point cloud to obtain a copy point cloud corresponding to the first to-be-fused point cloud; updating the copy point cloud and the first observation point cloud to obtain an updated copy point cloud and an updated first observation point cloud; and fusing the updated first observation point cloud and the updated copy point cloud to enable the updated copy point cloud and the updated first observation point cloud to be located at an updated zero isosurface.

14. The non-transitory computer-readable storage medium according to claim 13, wherein adjusting, based on the target deformation field, the current observation point cloud to obtain the first observation point cloud, comprises: adjusting, based on the target deformation field, normals and positions of current observation points in the current observation point cloud to obtain the first observation point cloud.

15. The non-transitory computer-readable storage medium according to claim 13, wherein the program or the instruction further implements operations comprising: updating, by using the first observation point cloud and the first to-be-fused point cloud, the copy point cloud; and updating, by using the first to-be-fused point cloud, the first observation point cloud.

16. The non-transitory computer-readable storage medium according to claim 15, wherein updating, by using the first observation point cloud and the first to-be-fused point cloud, the copy point cloud; and updating, by using the first to-be-fused point cloud, the first observation point cloud, comprises: for each copy point in the copy point cloud, determining, from the first observation point cloud and the first to-be-fused point cloud, points whose distance to the copy point is less than or equal to a first preset distance threshold for updating the copy point; and for each first observation point in the first observation point cloud, determining, from the first to-be-fused point cloud, a first to-be-fused point whose distance to the first observation point is less than or equal to a second preset distance threshold for updating the first observation point.

17. The non-transitory computer-readable storage medium according to claim 13, wherein updating the copy point cloud and the first observation point cloud to obtain the updated copy point cloud and the updated first observation point cloud comprises: updating, based on the first observation point cloud and the first to-be-fused point cloud, normals of copy points in the copy point cloud to obtain first copy points; updating, based on the first to-be-fused point cloud, normals of first observation points in the first observation point cloud to obtain normal-updated first observation points; updating, based on the first to-be-fused point cloud and the normal-updated first observation points, distances from the first copy points to the updated zero isosurface; and updating, based on the first to-be-fused point cloud, distances from the normal-updated first observation points to the updated zero isosurface; and fusing the updated first observation point cloud and the updated copy point cloud comprises: adjusting, based on normals of the first copy points and the distances from the first copy points to the updated zero isosurface, positions of the first copy points to obtain second copy points, wherein a distance from a second copy point to the updated zero isosurface is 0; and adjusting, based on normals of the normal-updated first observation points and the distances from the normal-updated first observation points to the updated zero isosurface, positions of the normal-updated first observation points to obtain second observation points, wherein a distance from a second observation point to the updated zero isosurface is 0.

18. The non-transitory computer-readable storage medium according to claim 17, wherein the program or the instruction further implements operations comprising: updating, based on the first to-be-fused points and the normal-updated first observation points, colors and weights of the second copy points; and updating, based on the first to-be-fused points, colors and weights of the second observation points.

19. The non-transitory computer-readable storage medium according to claim 17, wherein the program or the instruction further implements operations comprising:determining redundant points in the second copy points; and deleting the redundant points and the to-be-fused point cloud.

20. The non-transitory computer-readable storage medium according to claim 13, fusing the updated first observation point cloud and the updated copy point cloud to enable the updated copy point cloud and the updated first observation point cloud to be located at the updated zero isosurface, comprises:determining, based on distances from the updated copy point cloud to a zero isosurface and distances from the updated first observation point cloud to a zero isosurface, the updated zero isosurface; and moving the updated first observation point cloud and the updated copy point cloud onto the updated zero isosurface.
